(19) United States
(12) Patent Application Publication
(10) Pub. No.: US 2019/0176983 A1
(43) Pub. Date: Jun. 13, 2019

(54) RAPID AERIAL DEPLOYED DRONE

(71) Applicant: BRIAN D. DARNELL, Bonita, CA (US)

(72) Inventor: BRIAN D. DARNELL, Bonita, CA (US)

(21) Appl. No.: 16/172,234

(22) Filed: Oct. 26, 2018

Related U.S. Application Data
(60) Provisional application No. 62/578,262, filed on Oct. 27, 2017.

(51) Int. Cl. B64C 39/02; B64F 5/10; B64D 47/04; B64D 47/08; B64C 27/50; B64C 25/32

(52) U.S. Cl. CPC B64C 39/024; B64F 5/10; B64D 47/04; B64D 47/08; B64C 2201/126; B64C 25/32; B64C 2201/024; B64C 2201/20; B64C 27/50

(57) ABSTRACT

In some embodiments, an apparatus includes a fuselage of an unmanned aircraft that includes a first section removably coupled to a second section, and a third section removably coupled to the second section such that the second section is disposed between the first section and the third section in a vertical direction. The first section includes a first rotor and a second rotor disposed at a non-zero spaced distance in the vertical direction from each other. The first rotor and the second rotor share a common and aligned rotational axis defined along a longitudinal centerline of the fuselage defined in the vertical direction. The second section is configured to contain a selected payload, and the third section includes a control system. A plurality of legs are coupled to the third section and serve as landing gear for the unmanned aircraft.

### CROSS-REFERENCE TO RELATED APPLICATIONS

This application claims priority to and the benefit of U.S. Provisional Patent Application No. 62/578,262, entitled “Rapid Aerial Deployed Drone,” filed Oct. 27, 2017, the disclosure of which is incorporated herein by reference in its entirety.

### BACKGROUND

Embodiments are described herein that relate to a propeller-driven unmanned aerial vehicle, or also known as a drone.

Typical known unmanned aerial vehicles include single and multiple propeller axes of rotation, with most current designs favoring a four-propeller axes design which are referred to as a quadcopter design. Such drones require sufficient space between the propellers and are, therefore, typically not efficient in form/space utilization. Some known drones are also uniquely configured for a single particular purpose. For example, a drone may be configured with a camera to capture images or perform observational and metric surveillance, while other drones may be configured to transport an object.

A need exists for a new and/or improved unmanned aerial vehicle that can provide multi-functionality, and be efficient in form/space utilization (e.g., compact) to provide for easier transport and storage.

### SUMMARY

In some embodiments, an apparatus includes a fuselage and dual coaxial counter-rotating rotors in close proximity to one-another and sharing a common and aligned rotational axis. The rotors and motors are coupled to a bi-axial, servo controlled swash-plate assembly located in the fuselage. Each rotor is driven by a motor in a common aligned axis operatively coupled to a motor-shaft, enabling concentric and balanced torque to be achieved by the counter rotating rotors coupled to the motor shafts. The composite pitch angle of the propulsion section enables directional flight achieved by a vectoring of the propulsion section by bi-axial servos controlled electronically by a computer control system. The control system can have a computer-based controller, at least one accelerometer, at least one gyroscope, a wireless interface, ground sensing telemetric sensor(s) and a wireless transceiver. The on-board control system can receive commands from a remote flight control platform via the wireless transceiver, and determine a rotor speed and swash-plate pitch angles necessary to achieve the flight commands of the remote controller. Alternatively or in addition, some or all of the commands may be pre-programmed within a memory associated with the controller prior to operation of the apparatus.

### BRIEF DESCRIPTION OF THE FIGURES

FIG. 1 is a schematic illustration of a rotorcraft, according to an embodiment.

FIG. 2A is a schematic illustration of the rotorcraft of FIG. 1 shown in a first configuration for use, and FIG. 2B is a schematic illustration of the rotorcraft of FIG. 2A shown in a second configuration for storage and transport.

FIG. 3 is a side view of a rotorcraft, according to another embodiment.

FIG. 4 is a side view of the rotorcraft of FIG. 3 with portions of the interior of the rotorcraft visible showing interior components of the rotorcraft.

FIG. 5A is an enlarged side view of the propulsion section and payload section of the rotorcraft of FIG. 4, showing some interior components of the rotorcraft.

FIG. 5B is an enlarged side view of the power, optics and guidance section of the rotorcraft of FIG. 4, showing some interior components of the rotorcraft.

FIG. 6A is a side view of a portion of a leg of the rotorcraft of FIG. 3 illustrating an embodiment of the leg having a delivery catheter.

FIG. 6B is a side view of a portion of a leg of the rotorcraft of FIG. 3 illustrating an embodiment of the leg having a lighting device disposed within the landing foot.

FIG. 7 is a top view of the rotorcraft of FIG. 3.

FIG. 8 is a bottom view of the rotorcraft of FIG. 3.

FIG. 9 is a side view of a rotorcraft, according to another embodiment.

FIG. 10 is a side view of the rotorcraft of FIG. 9 rotated ninety degrees relative to the side view of FIG. 9.

FIG. 11 is a top perspective view of the rotorcraft of FIG. 9.

FIG. 12 is a bottom perspective view of the rotorcraft of FIG. 9, with a portion of the bottom of the housing removed for illustration purposes.

FIG. 13 is a top view of the rotorcraft of FIG. 9.

FIG. 14 is a bottom view of the rotorcraft of FIG. 9.

### DETAILED DESCRIPTION

Apparatus are described herein for an unmanned aerial vehicle, or rotorcraft, that includes a fuselage and dual coaxial counter-rotating rotors in close proximity to one-another and sharing a common and aligned rotational axis. The rotors and motors are coupled to a bi-axial, servo controlled swash-plate assembly located in the fuselage. Each rotor is driven by a motor in a common aligned axis operatively coupled to a motor-shaft, enabling concentric and balanced torque to be achieved by the counter rotating rotors coupled to the motor shafts. The composite pitch angle of the propulsion section enables directional flight achieved by a vectoring of the propulsion section by bi-axial servos controlled electronically by a computer control system. The control system can have a computer-based controller, at least one accelerometer, at least one gyroscope, a wireless interface, ground sensing telemetric sensor(s) and a wireless transceiver. The on-board control system can receive commands from a remote flight control platform via the wireless transceiver, and determine a rotor speed and swash-plate pitch angles necessary to achieve the flight commands of the remote controller. Alternatively or in addition, some or all of the commands may be pre-programmed within a memory associated with the controller prior to operation of the apparatus.

In some embodiments, an unmanned-aerial vehicle (UAV) or drone or rotorcraft is provided that is a battery-operated, portable hand-held or tube launched counter-rotational rotor driven, vector-directed semi-autonomous UAV, with a user configurable mission-based platform. The UAVs described herein provide a small form factor and concentric design, portability, rapid deployability and user-configurable format. For example, in some embodiments, a UAV described herein can provide lethal and non-lethal weaponization, which can have uses in military, utility, first-responder, security and law enforcement applications and uses in other service functions such as search and rescue, chemical detection, cellular communication node bridging, and other non-military tactical applications.

In some embodiments, a rotorcraft as described herein can be a modular assembly having coaxial counter-rotating rotors in close proximity to one-another and positioned in the fuselage of the rotorcraft. The counter-rotating rotors are coupled to a bi-axial, servo controlled swash-plate assembly. The counter-rotating rotors generate the forces necessary to lift the rotorcraft and maneuver it in the air by vectoring control being actioned by servo(s), and the pitch angle of the propulsion section enables vertical take-off and landing (VTOL), vertical climb, hovering and horizontal flight. The propulsion section also allows the ability to vertically descend at a fixed or variable rate of pitch and velocity by vectoring of the swash-plate assembly and adjusting of the lifting power by attenuation of rotor speed.

The rotorcrafts described herein can be constructed with, for example, various lightweight manufacturing materials, and electronic components. For example, in some embodiments, the rotorcrafts can be constructed with aircraft grade composite materials. The rotorcrafts can provide a modular design that allows for quick assembly and dis-assembly (e.g., in less than one minute). The modular design of the rotorcraft allows the rotorcraft to be easily equipped to perform multiple different functions and capabilities, such as, for example, capabilities for video, photography, entertainment, surveillance, both observational and metric, chemical detection, offensive and defensive military operations/policing and security missions.

In some embodiments, an apparatus includes a fuselage of an unmanned aircraft that includes a first section removably coupled to a second section, and a third section removably coupled to the second section such that the second section is disposed between the first section and the third section in a vertical direction. The first section includes a first rotor and a second rotor disposed at a non-zero spaced distance in the vertical direction from each other. The first rotor and the second rotor share a common and aligned rotational axis defined along a longitudinal centerline of the fuselage defined in the vertical direction. The second section is configured to contain a selected payload, and the third section includes a control system. A plurality of legs are coupled to the third section and serve as landing gear for the unmanned aircraft.

In some embodiments, an apparatus includes a fuselage of an unmanned aircraft that includes a housing having a length and a width. The length is defined in a vertical direction and the width is defined substantially perpendicular to the length. The fuselage including a housing, a first rotor coupled to the housing and a second rotor coupled to the housing and disposed at a non-zero spaced distance in the vertical direction from the first rotor. The first rotor and the second rotor are each configured to be moved between a first configuration in which the first rotor and the second rotor are disposed at substantially ninety degrees relative to an outer surface of the housing of the fuselage for use of the unmanned vehicle, and a second configuration in which the first rotor and the second rotor are disposed substantially parallel to a longitudinal centerline of the fuselage defined along the length of the fuselage for storage and transport of the unmanned vehicle. A plurality of legs coupled to the fuselage. The plurality of legs can each be moved between a first configuration in which the legs are extended for use as landing gear for the unmanned vehicle and a second configuration in which the plurality of legs are disposed at least partially within a portion of the housing for storage and transport of the unmanned vehicle.

In some embodiments, an apparatus includes a fuselage of an unmanned aircraft that includes a housing having a length and a width. The length is defined in a vertical direction and the width is defined substantially perpendicular to the length. A first rotor and a second rotor are each coupled to the housing and disposed at a non-zero spaced distance in the vertical direction from each other. The first rotor and the second rotor share a common and aligned rotational axis defined along a longitudinal centerline of the fuselage. A first motor is included within the housing and operatively coupled to the first rotor, and a second motor included within the housing and operatively coupled to the second rotor. The first motor and the second motor are each aligned with the first rotor and the second rotor along the longitudinal centerline of the fuselage. A power source is disposed within the housing and operatively coupled to the first motor and to the second motor.

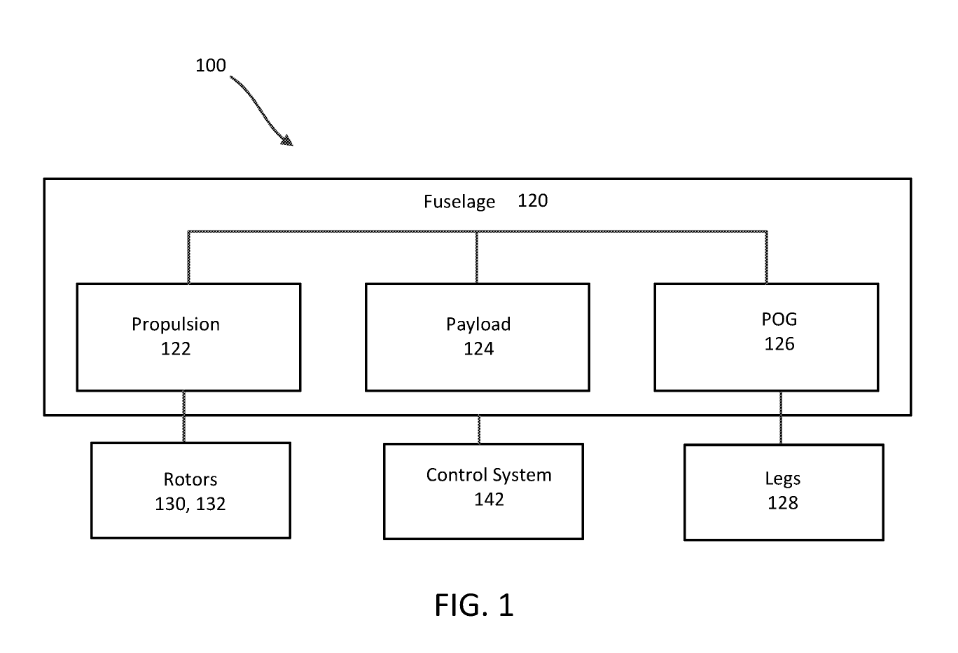

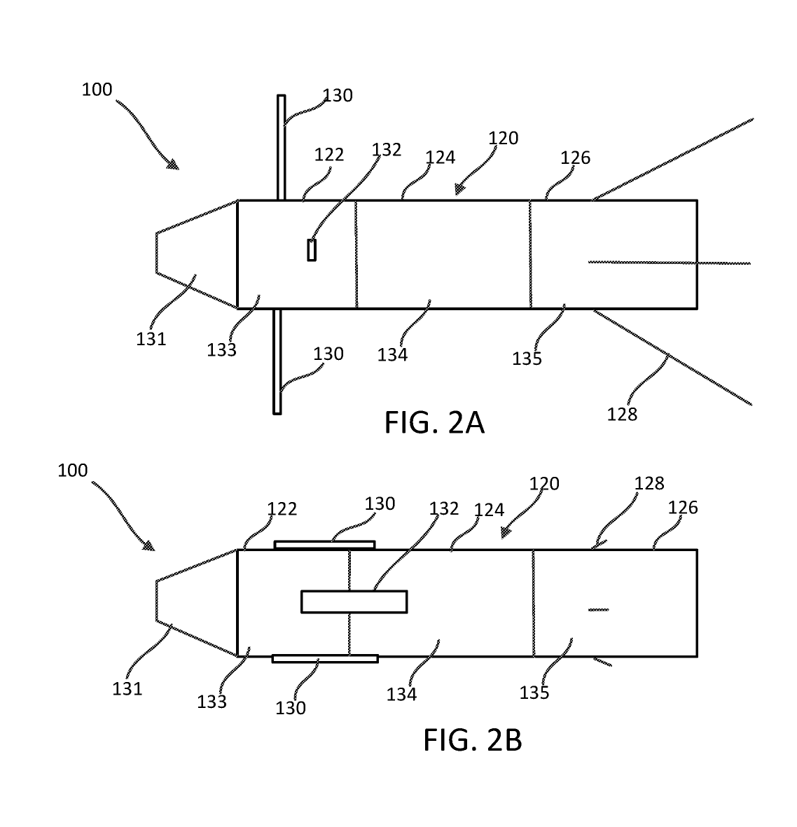

FIGS. 1-2B are schematic illustrations of an unmanned-aerial vehicle (UAV) (also referred to herein as “drone” or “rotorcraft”) 100, according to an embodiment. FIG. 1 is a schematic representation of the rotorcraft 100 illustrated in FIGS. 2A and 2B. The rotorcraft 100 includes a fuselage 120 that can include multiple sections that can be releasably coupled together. For example, as shown in FIG. 1-2B, the rotorcraft 100 includes a propulsion section 122, a payload section 124 and a power, optics and guidance (POG) section 126. The three sections 122, 124, and 126 can each include a fuselage housing portion 133, 134 and 135, respectively and can be coupled together via the housings 133, 134, 135 with a variety of different coupling methods, such as, for example, a threaded coupling, fasteners such as threaded fasteners (e.g., bolts, screws), snap-fit-release mechanisms, snapping lap-joints, overlapping compression joints, and the like. The coupling device/mechanism can be coupled to or incorporated with the housings 133, 134, 135. The propulsion section 122 can include a tapered or cone shaped top housing portion 131 that can a separate component and releasable or fixedly coupled to the housing portion 133 or be integrally formed with the housing portion 133. The releasable coupling of the three sections of the rotorcraft 100 allows for the payload section 124 to be easily removed from the propulsion section 122 and the POG section 126, such that the payload within the payload section 124 can be replaced with different payloads configured for different uses, or supplementing one payload section (module) with another payload section module. Thus, the rotorcraft 100 can be easily reconfigured for different uses.

The three inter-locking sections 122, 124, 126 of the fuselage 120 can be spline-contoured substantially cylindrically shaped sections serving as discrete modules or sections (e.g., the propulsion section 122, the payload section 124 and the POG section 126). In some embodiments, the outer surface of the housings 133, 134, 135 of the fuselage 120 can include faceted geometric surface patterns, such as, for example, rectangular or triangular shaped faceted surface sections. In other embodiments, the outer surface of the fuselage may include other types of surface patterns or lack any such patterns. In this embodiment, the faceted geometry of the spline-shaped cylindrical fuselage 120 can provide a radar absorbing material (RAM) glazed finish to help disguise the rotorcraft from radar detection, and 3D printed embedded electrical circuitry. In some embodiments, the outer surface of the fuselage 120 can be smooth or substantially smooth.

The payload section 124 serves as both a mechanical coupler of the POG and propulsion sections and is an interchangeable platform designed to house a variety of different payloads, such as, but not limited to: an aerosol cartridge, micro-explosive ordnance, electronic communications hardware, chemical, bio-chemical detection sensors, pharmaceutical lancets or small-parcel capsule. In some embodiments, the payload within the payload section 124 can be an electronically controlled gas-pressurized aerosol cartridge. In some embodiments, the payload can include a micro-explosive ordinance, for example, a Dense Inert Metal Explosive (DIME). In such an embodiment, the shell or outer fuselage housing 134 of the payload section 124 can be a weakened-plane faceted geometry made of metal, plastic and or other light-weight industrial materials. Thus, when subjected to the explosive internal forces from the integrated micro-explosive, the housing of the payload section 124 disintegrates into a shaped fragmentation munition of programmable force by selection of explosive compound and payload shell configuration. This action is potentially lethal and obliterates the rotorcraft 100 upon use.

The propulsion section 122 of the rotorcraft 100 can include counter-rotating rotors (also referred to as “propellers”) 130 and 132 coupled to the fuselage in close proximity to each other and at a top or forward end portion of the fuselage 120. The two rotors 130, 132 are coupled to a bi-axial, servo controlled swash-plate assembly and share a common and aligned rotational axis (not shown in FIGS. 1-2B). The swash-plate assembly can be a known standard device within a rotor assembly of a helicopter or other like aerial machine and can be used to adjust the angle of the rotor blades in response to external commands (e.g., from a flight control program or pilot). In some embodiments, the rotors 130, 132 can be foldable. In other words, the rotors 130, 132 can be moved to a first configuration in which the rotors 130, 132 are extended radially outward from the fuselage 120 (e.g., disposed at a substantially 90 degree angle relative to a longitudinal axis of the fuselage 120 for use of the rotorcraft 100 as shown in FIG. 2A. The rotors 130, 132 can be moved, or automatically descend, to a second configuration in which the rotors 130, 132 are positioned downward to a position substantially parallel to the longitudinal axis of the fuselage 120 as shown in FIG. 2B. In the second configuration, the rotorcraft 100 can have a smaller form factor for transport, storage and repowering of the rotorcraft 100. Each rotor 130, 132 includes or is coupled to a motor and in one embodiment can be disposed in a common aligned axis. Such alignment enables concentric and balanced torque to be achieved by means of the counter rotating rotors attached to the motor shafts. The motors can be, for example, an electric motor. In other embodiments, in a rotorcraft 100 having, for example, a larger form factor, can be powered by, for example, electricity, fuel cells, air-battery, liquid fuel, solid fuel, etc.

The composite pitch angle of the propulsion section enables directional flight and is achieved by a vectoring of the propulsion section by bi-axial servos controlled electronically by a computer control-system 142. The control-system 142 can have a computer-based controller, at least one accelerometer, at least one gyroscope, a wireless interface, ground sensing telemetric sensor(s) and a wireless transceiver. In some embodiments, the control system 142 may utilize an open source software architecture comprised of, for example, the Px4 Flight Stack or the APM Flight Stack as known in the art and incorporated herein by reference. The control system 142 can receive commands from a remote flight control platform through the wireless transceiver (not shown in FIGS. 1-2B), and determine the rotor speed and swash-plate pitch angles necessary to achieve the flight commands received from a remote controller (not shown). Alternatively, some or all of the commands may be pre-programmed within a memory associated with the on-board control system 142 prior to operation of the rotorcraft 100.

The POG section 126 includes three flexible legs 128 positioned in 120 degree radial increments about the fuselage 120 and extending radially outward and downwardly from the fuselage 120. In some embodiments, the legs 128 extend downwardly from the fuselage 120 approximately ⅓ of a total length of the fuselage 120 from the POG section. The legs 128 can provide a variety of purposes and functions. For example, the legs 128 can serve as the landing gear, and can also include other components such as, for example, integrated navigation lights, an antenna (e.g., a communications antenna), and provide an aerosol delivery catheter. For example, the delivery catheter can be defined by the leg 128 itself or can be provided by another component disposed within or coupled to one or more legs 128. In some embodiments, the legs 128 can be formed with semi-rigid engineered plastic, flexible metal cable, carbon fiber, fiberglass and other industrial tubing products. An interchangeable landing shoe can be located at the base of each leg to serve as a surface foot. In some embodiments, the landing shoe (not shown in FIGS. 1, 2A-2B) on at least one leg 128 can provide illumination. For example, the landing shoe can be illuminated by a light emitting diode (LED) or fiber optic cable, enabling the leg(s) 128 to serve as a navigation light or other illuminated visual marker. The LED or fiber-optic cable lead can be connected to a control board, which can receive various commands from a wireless remote controller and transmit those commands to the various electronic components of the rotorcraft 100, including the led navigation light and other illuminated visual marker functions. The landing shoe can be of various shapes and terminal function for mission specific purposes and varied geological conditions.

The control board can provide for flight controls, GPS/navigation and guidance of the rotorcraft 100. For example, the rotorcraft 100 can include GPS/navigation guidance system that provides for first-person-view (FPV) capabilities that allow the rotorcraft 100 to be piloted by conventional radiofrequency (RF) and/or digital signal via WIFI or satellite.

In some embodiments, one or more legs 128 can encase a spark-firing electrode that can run the length of the leg 128 and be connected to the control board, which as discussed above can receive various commands from the wireless remote controller and transmit those commands to the electrode. In some embodiments, a leg 128 can define a catheter lumen, or encase a catheter that can be used to convey material from an aerosol gas cartridge in the payload section 124 by means of pressurized aerosol being released by an electronically controlled valve discharging various gas elements from the gas cartridge.

The POG section 126 can also include a power source, speaker(s), a motorized digital camera, light emitting diode (e.g., LED ring), integrated microphone(s), and/or various sensors. The power source can be, for example, a battery, providing for portability of the rotorcraft 100. However, in other embodiments power sources other than batteries may be utilized. In some embodiments, the POG section includes a motorized digital camera (not shown in FIGS. 1-2B) with, for example, visual (photographic and video), radiometric thermal imaging, and aerial mapping capabilities. The camera can be disposed on a multi-axis gimbal with an integrated stabilizing device and be operatively coupled to the control board for control and operation. A portion of the fuselage 120 disposed at a bottom portion of the POG section 126 can be formed with a clear polycarbonate lens to allow for images to be taken by the camera through the fuselage 120. In some embodiments, the camera can be, for example, a hi-resolution digital camera on multi-axis gimble for tilt and panning capabilities.

In some embodiments, the POG section 126 includes a speaker or speakers such as, for example, digital micro-electromechanical-speakers (MEMS). Speakers can be used, for example, to provide audio capabilities such as providing an audible emergency notification and instruction, disruptive and or destructive audio engagement in hostile theaters of conflict or benign music or recorded material playback. In some embodiments, the POG section 126 includes a microphone or microphones with built-in noise canceling DSP (Digital Signal Processor) positioned about the circumference of the rotorcraft 100 for remote audio monitoring and at source communication.

In some embodiments, the POG section includes bio-aerosol detection and infra-red sensors positioned about the circumference of the rotorcraft 100. In some embodiments, the POG section 126 can include ultra-sound sensors for altitude/attitude control.

The legs 128 can also be retractable or repositionable to a location within the fuselage for storage and transport. For example, as shown in FIG. 2A, the legs 128 can be in a first configuration in which the legs are extended for use of the rotorcraft 100, and can be moved to a second configuration in which the legs 228 are disposed fully or substantially within the fuselage 120, as shown in FIG. 2B, for storage and transport. The folding propeller blades (e.g., rotors 130, 132), and retractable landing gear (e.g., legs 128), provide for a compact small form factor configuration for storage and transport of the rotorcraft 100. For example, the rotorcraft together with a storage/launch tube with integrated charger (not shown) can have an overall outer length between, for example, about 16 inches and about 20 inches, and an outer diameter between, for example, about 3 inches and about 4 inches, and can in some embodiments, weigh about less than 5 pounds. Thus, the size of the rotorcraft 100 and charger allows for them to be stored within a package, such as a backpack, suitcase, shoulder bag or small travel bag.

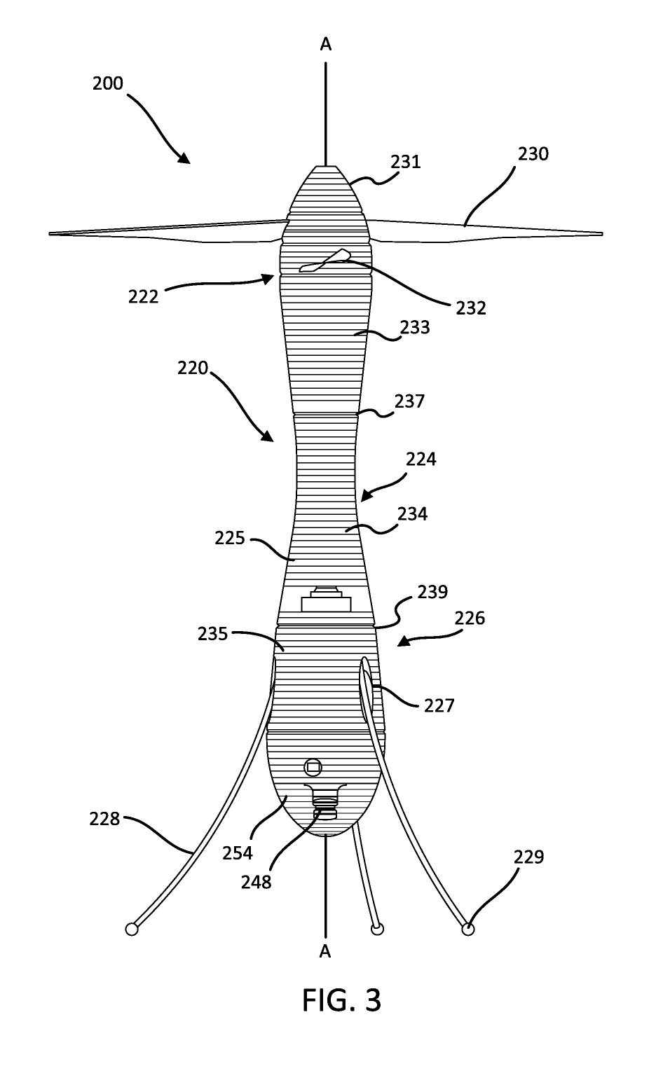

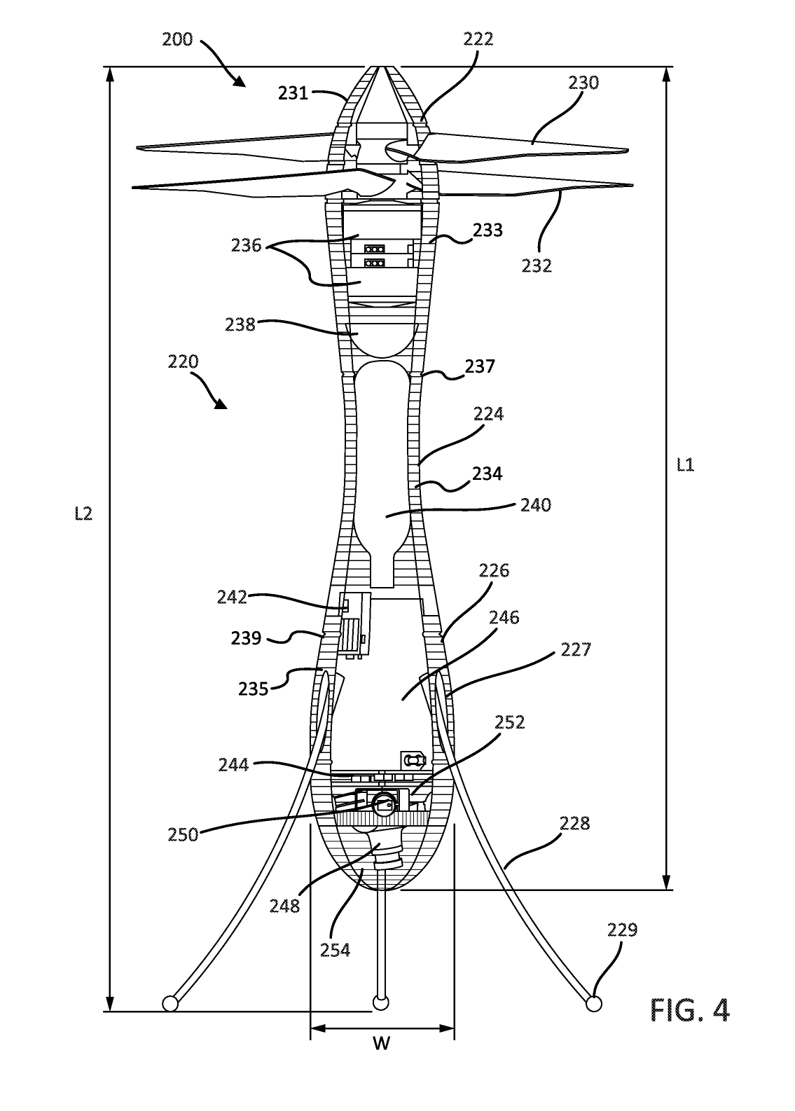

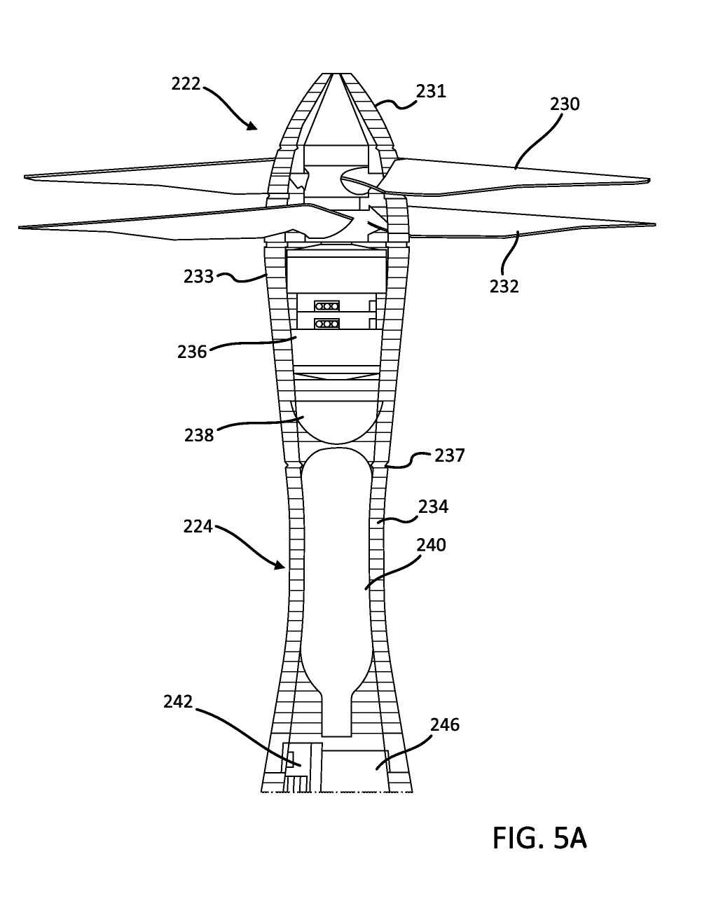

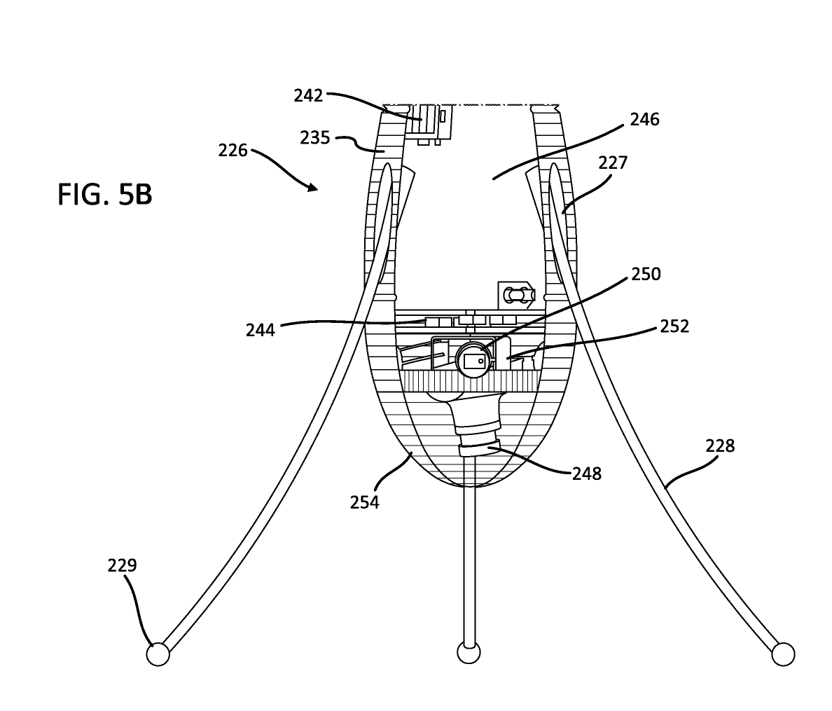

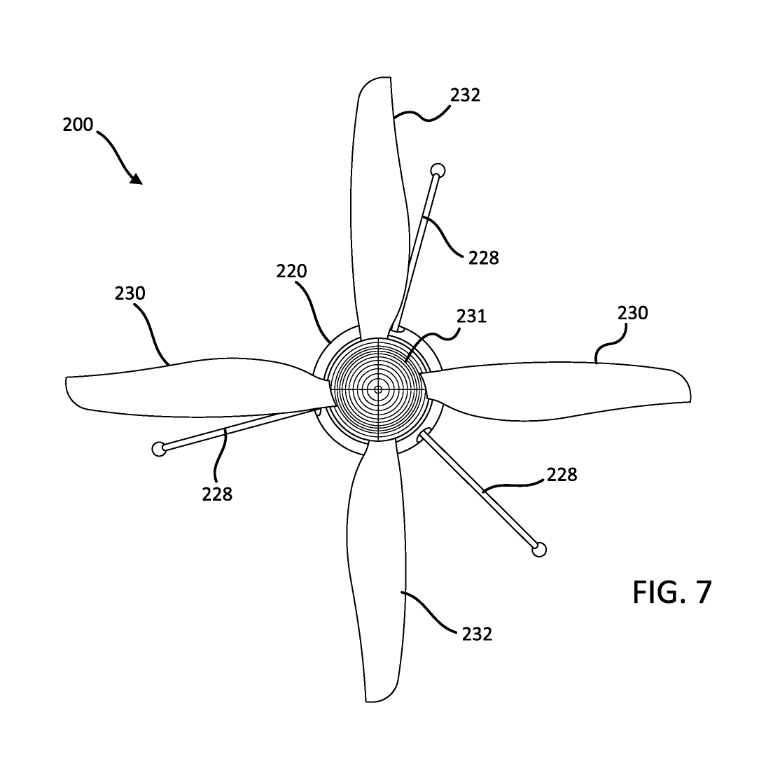

FIGS. 3-8 illustrate an unmanned-aerial vehicle (UAV) (also referred to herein as “drone” or “rotorcraft”) 200, according to another embodiment. The rotorcraft 200 includes a fuselage 220 that can include multiple sections that can be releasably coupled together. As shown, for example, in FIGS. 3 and 4, in this embodiment, the rotorcraft 200 includes a propulsion section 222, a payload section 224 and a power, optics and guidance (POG) section 226. As described above for rotorcraft 100, the propulsion section 222 includes a housing portion 233, the payload section includes a housing portion 234 and the POG section 226 includes a housing portion 235. The housing portions 233, 234 and 235 can be releasably coupled together, for example, at joints 237 and 239 to couple the sections 222, 224 and 226 together. The three sections 222, 224, 226 can be coupled together with a variety of different coupling methods, such as, for example, a threaded coupling, fasteners such as threaded fasteners (e.g., bolts, screws), snap-fit-release mechanisms, snapping lap-joints, overlapping compression joints, etc. The coupling device/mechanisms can be coupled to or incorporated with the housings 233, 234, 235. The propulsion section 222 can include a tapered or cone shaped top housing portion 231 that can a separate component and releasable or fixedly coupled to the housing portion 233 or be integrally formed with the housing portion 233. The releasable coupling of the three sections of the rotorcraft 200 allows for the payload section 224 to be easily removed from the propulsion section 222 and the POG section 226, such that the payload within the payload section 224 can be replaced with different payloads configured for different uses, or supplementing one payload section (module) with another payload module. Thus, the rotorcraft 200 can be easily reconfigured for different uses.

The three inter-locking sections 222, 224, 226 of the fuselage 220 can be spline-contoured substantially cylindrically shaped sections serving as discrete modules or sections (e.g., the propulsion section 222, the payload section 224 and the POG section 226). The outer surface 225 of housings 133, 134, 135 of the fuselage 220 can include faceted geometric surface patterns or be smooth. The faceted geometry of the spline-shaped cylindrical fuselage 220 can provide a radar absorbing material (RAM) glazed finish to help disguise the rotorcraft from radar detection, and 3D printed embedded electrical circuitry. In this embodiment, the outer surface 225 of the fuselage 220 includes faceted surface patterns, which are rectangular shaped. The fuselage 220 can have a length L1 measured from a first end to a second end of the fuselage 220, and a width W defined perpendicular to the length, as shown in FIG. 4. As shown in FIG. 4, the length L1 is defined in a vertical direction and the width W is defined in a horizontal direction. As also shown in FIG. 4, the width W of the fuselage 220 can vary. In other embodiments, the width W may not vary. The rotorcraft 200, including the fuselage and the legs (discussed below) when in a ready-to-use configuration can have a length L2, as shown in FIG. 3. In some embodiments, the length L1 can be, for example, between about 15 inches and about 17 inches, and the length L2 can be, for example, between about 12 inches and about 15 inches. In some embodiments, the length L1 can be, for example, at or about 16 inches, and the length L2 can be, for example, at or about 13 inches.

The propulsion section 222 of the rotorcraft 200 includes counter-rotating rotors (also referred to as “propellers”) 230 and 232 coupled to the fuselage 220 in close proximity to each other and at a top or forward end portion of the fuselage 220. The two rotors 230, 232 share a common and aligned rotational axis A-A (see FIG. 3), which is the longitudinal center axis of the fuselage 220. In one embodiment, the rotors 230, 232 are each coupled to a motor 236 (see FIG. 4) and disposed in a common aligned axis (e.g., axis A-A) within an interior region or volume of the propulsion section 222. The rotors 230, 232 can also be coupled to a bi-axial, servo controlled swash-plate assembly 238 and share a common and aligned rotational axis (e.g., axis A-A) within an interior region or volume of the propulsion section 222. As described above for rotors 130, 132, the rotors 230, 232 can be foldable. In other words, the rotors 230, 232 can be moved to a first configuration in which the rotors 230, 232 are extended radially outward from the fuselage 220 (e.g., disposed at a substantially 90 degree angle relative to a longitudinal axis of the fuselage 220) and locked in place for use of the rotorcraft 200, as shown in FIGS. 3-5, 7 and 8. The rotors 230, 232 can be moved to a second configuration in which the rotors 230, 232 are folded downward to a position substantially parallel to the longitudinal axis of the fuselage 220 (not shown), as described above for rotors 130, 132. For example, the rotors 232 and 234 can be hingedly coupled within the propulsion section 222 to provide for movement of the rotors 232, 234 between the first and second configurations.

The payload section 224 serves as both a mechanical coupler of the POG section 226 and the propulsion section 222, and can provide for interchangeability of a variety of different payloads, such as, but not limited to: an aerosol cartridge, micro-explosive ordnance, or small-parcel capsule as described above for rotorcraft 100. The payload section 224 can include a payload 240 that can be removably interchangeable as described above. As shown in FIGS. 3 and 4, the payload 240 in this embodiment includes an electronically triggered gas-pressured aerosol cartridge. The payload 240 can be operatively coupled to the system controller (described below) and coupled to a catheter disposed within a leg of the rotorcraft 200 as described in more detail below.

An on-board radio frequency (RF) transceiver system 242 is provided within the (POG) section 226, as shown in FIGS. 3-5. The composite pitch angle of the propulsion section 222 enables directional flight and is achieved by a vectoring of the propulsion section 222 by bi-axial servos controlled electronically by a flight-control-system 244. The flight-control-system 244 can include, for example, a computer-based controller, at least one accelerometer, at least one gyroscope, a wireless digital interface, and a wireless digital transceiver. The control system 244 can receive commands from a remote flight control platform through a wireless transceiver within the flight-control system and determine the rotor speed and swash-plate pitch angles necessary to achieve the flight commands received from a remote controller (not shown). Alternatively, some or all of the commands may be pre-programmed within a memory associated with the control system 244 prior to operation of the rotorcraft 200.

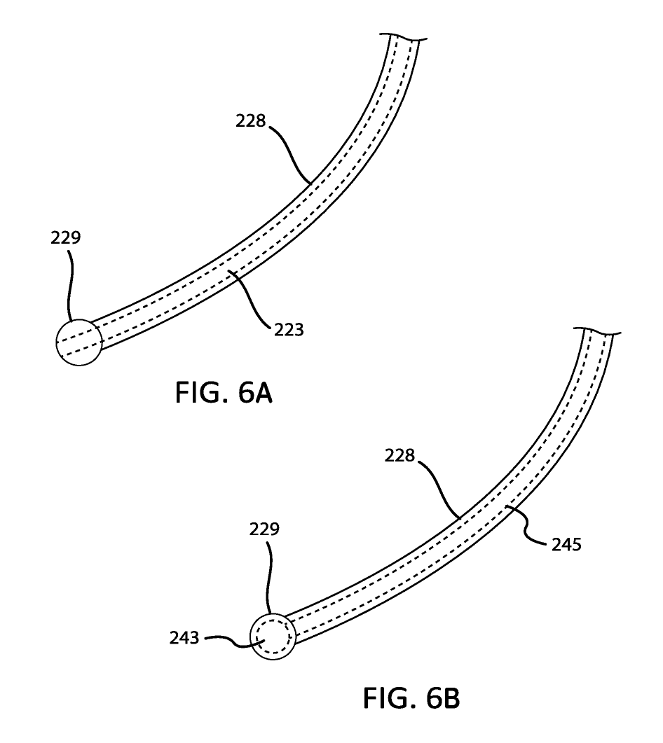

The POG section 226 includes three flexible legs 228 positioned in 120 degree radial increments about the fuselage 220 and extending radially outward and downwardly from the fuselage 220. In some embodiments, the legs 228 extend downwardly from the fuselage 220 approximately ⅓ of a total length of the fuselage 220 from the POG section. The legs 228 can provide a variety of purposes and functions. For example, the legs 228 can serve as the landing gear, and can also include other components such as, for example, integrated navigation lights, an antenna (e.g., a communications antenna), and provide an aerosol delivery catheter. For example, a delivery catheter or lumen 223 can be defined by the leg 228 itself (as shown in FIG. 6A) or can be provided by another component disposed within or coupled to one or more legs 228. The lumen 223 can be in fluid communication with, for example, and opening in the landing foot to allow for delivery of a payload (e.g., an aerosol) as desired. In some embodiments, the legs 228 can be formed with, for example, semi-rigid engineered plastic, flexible metal cable, carbon fiber, fiberglass and/or other industrial tubing products. An interchangeable landing shoe 229 can be located at the base of each leg to serve as a surface foot. In some embodiments, the landing shoe 229 on at least one leg 228 can provide illumination. For example, the landing shoe 229 can be illuminated by a light emitting diode (LED) (see 243 in FIG. 6B) or fiber optic cable, enabling the leg(s) 228 to serve as a navigation light or other illuminated visual marker. The LED or fiber-optic cable lead (see 245 in FIG. 6B) can be connected to a control board, which can receive various commands from a wireless remote controller and transmit those commands to the various electronic components of the rotorcraft 200, including the led navigation light and other illuminated visual marker functions. The landing shoe 229 can be of various shapes and terminal function for mission specific purposes and varied geological conditions.

The control system 244 can include a control board that can provide for flight controls, GPS control, navigation and guidance of the rotorcraft 200. For example, the rotorcraft 200 can include a GPS/navigation guidance system that provides for first-person-view (FPV) capabilities that allow the rotorcraft 200 to be piloted by conventional radiofrequency (RF) and/or digital signal via WIFI or satellite.

In some embodiments, one or more legs 228 can encase wires that can run the length of the leg 228 and be connected to a spark-firing electrode that would take the position of the landing shoe 229. The wires can be connected to the control board, which as discussed above can receive various commands from the wireless remote controller and transmit those commands to the electrode.

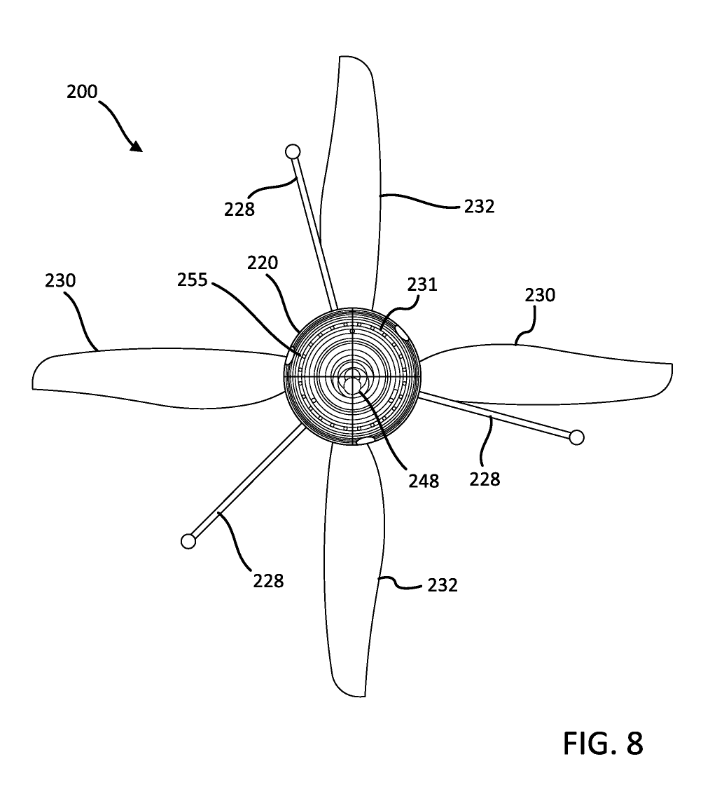

The POG section 226 can also include a power source 246, speaker(s), a motorized digital camera, light emitting diode(s) (e.g., LED ring 255 shown in, for example, FIG. 8), integrated microphone(s), and/or various sensors. In some embodiments, the power source can be a battery to provide for portability of the rotorcraft 200. In some embodiments, the POG section includes a motorized digital camera 248 (shown in FIGS. 3, 4, 6, and 8) with, for example, visual (photographic and video), radiometric thermal imaging, and aerial mapping capabilities. The camera 248 can be disposed on a multi-axis gimbal with an integrated stabilizing device and be operatively coupled to the control board for control and operation. A portion 254 of the fuselage 220 disposed at a bottom portion of the POG section 226 can be formed of a clear polycarbonate material providing a clear protective cover to allow for clear imaging by the camera. In some embodiments, the camera 248 can be, for example, a hi-resolution digital camera on multi-axis gimble for tilt and panning capabilities.

In some embodiments, the POG section 226 includes a speaker or speakers (not shown), such as, for example, digital micro-electromechanical-speakers (MEMS). Speakers can be used, for example, to provide audio capabilities such as providing an audible emergency notification and instruction, disruptive and or destructive audio engagement in hostile theaters of conflict or benign music or recorded material playback. In some embodiments, the POG section 226 includes a microphone or microphones 250 (e.g., see FIGS. 4 and 6). The microphones 250 can be disposed about the circumference of the rotorcraft 200. In some embodiments, the microphones 250 can include a hyper-directional microphone with built-in noise canceling DSP (Digital Signal Processor) for remote audio monitoring and at source communication.

The POG section 226 can also include one or more of various types of sensors 252, such as, for example, chemical detection and infra-red sensors housed within and located about POG section 226 (FIG. 6). In some embodiments, the POG section 226 can include ultra-sound sensors for altitude/attitude control. The sensors 252 can also be disposed about the circumference of the rotorcraft 200. As described for rotorcraft 100, the legs 228 can also be retractable to a location within the fuselage or folded inward towards the fuselage 220 for storage and transport. For example, as shown in FIGS. 3, 4 and 6, the legs 228 can be in a first configuration in which the legs 228 are extended for use of the rotorcraft 200, and can be moved to a second configuration (not shown) in which the legs 228 are disposed fully or substantially within the fuselage 220 (not shown) for storage and transport. For example, the legs 228 can be retracted into POG section 226 of the fuselage 220 through openings 227 defined in the fuselage 220.

The folding propeller blades (e.g., rotors 230, 232), and retractable landing gear (e.g., legs 228), provide for a compact configuration for storage and transport of the rotorcraft 100 as described above for rotorcraft 100.

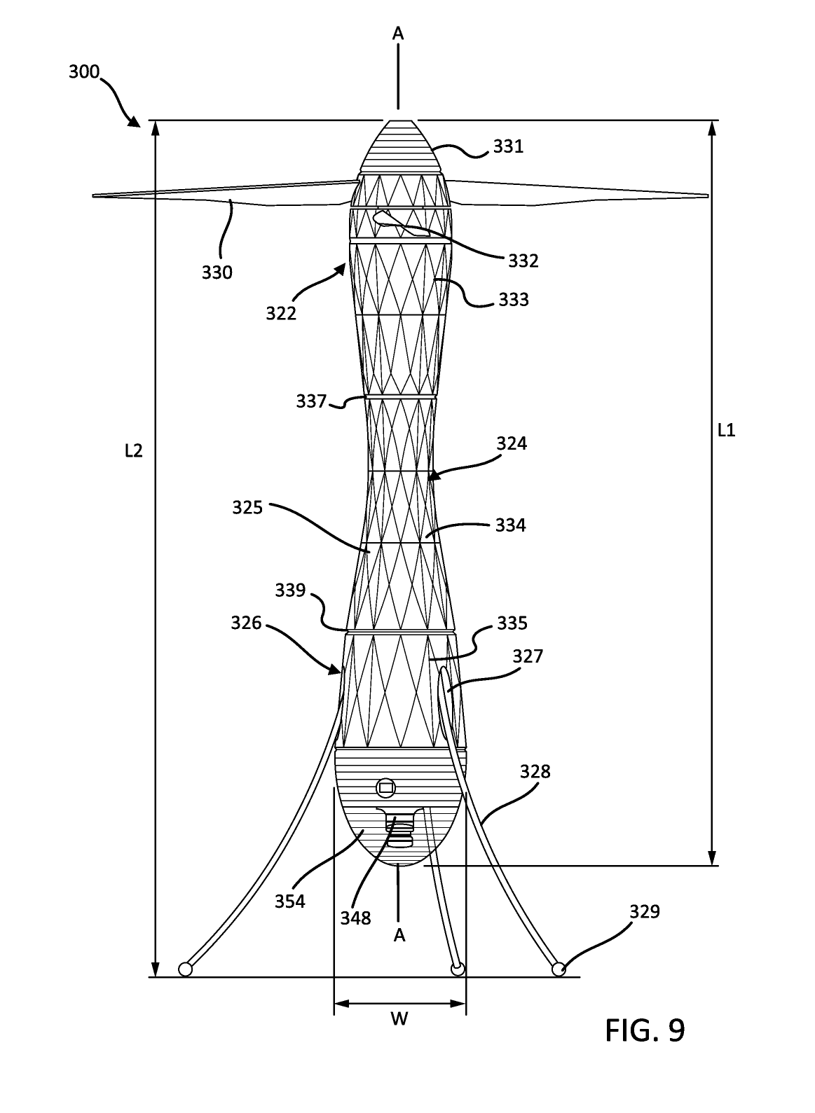

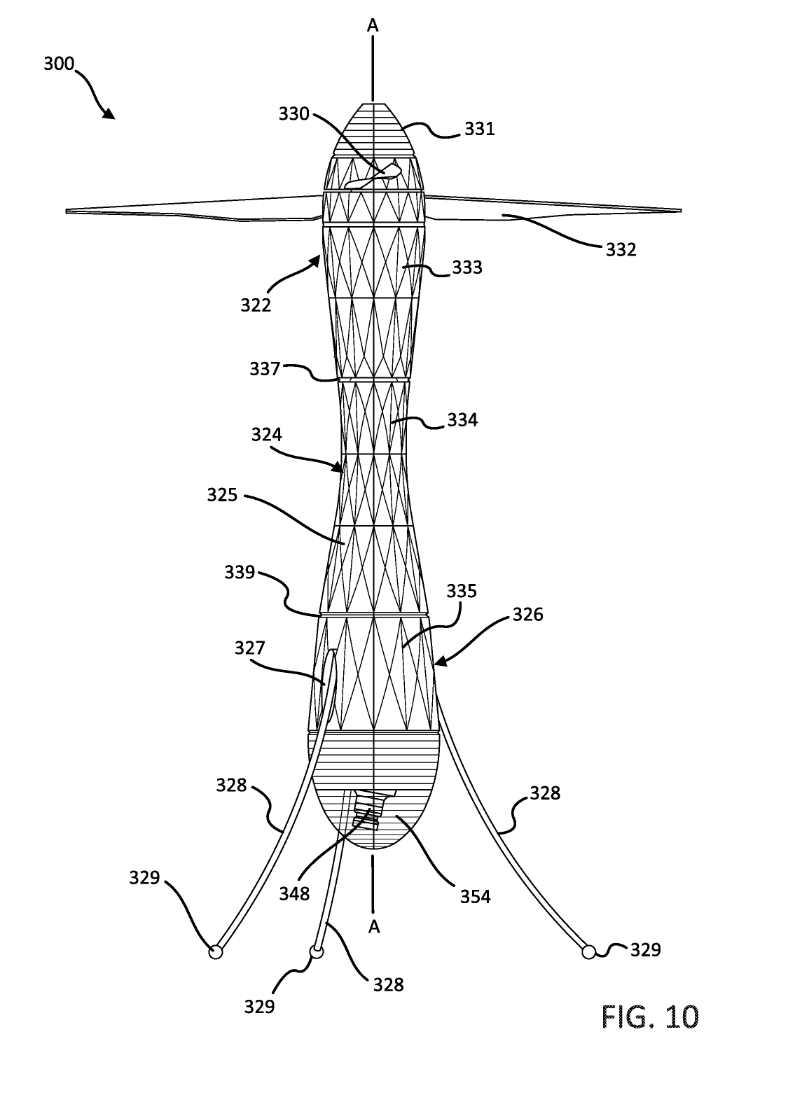

FIGS. 9-13 illustrate an unmanned-aerial vehicle (UAV) (also referred to herein as “drone” or “rotorcraft”) 300, according to another embodiment. The rotorcraft 300 can be constructed substantially the same as or similar to the rotorcrafts 100 and 200 described above and be used for the same or similar functions. Thus, some features and components of the rotorcraft 300 are not described below. For example, the rotorcraft 300 includes a fuselage 320 that includes three sections that are releasably couplable. More specifically, the rotorcraft 300 includes a propulsion section 322, a payload section 324 and a power, optics and guidance (POG) section 326. As described above for rotorcrafts 100 and 200, the propulsion section 322 includes a housing portion 333, the payload section includes a housing portion 334 and the POG section 326 includes a housing portion 335. The housing portions 333, 334 and 335 can be releasably coupled together, for example, at joints 337 and 339 to couple the sections 322, 324 and 326 together. The three sections can be coupled together with a variety of different coupling methods, such as, for example, a threaded coupling, fasteners such as threaded fasteners (e.g., bolts, screws), etc. as described above for previous embodiments. The propulsion section 322 can include a tapered or cone shaped top housing portion 331 that can a separate component and releasable or fixedly coupled to the housing portion 333 or be integrally formed with the housing portion 333. As described above, the releasable coupling of the three sections of the rotorcraft 300 allows for the payload section 324 to be easily removed from the propulsion section 322 and the POG section 326, to for example, change a payload within the payload section 324.

The three inter-locking sections of the fuselage 320 can be spline-contoured substantially cylindrically shaped sections serving as discrete modules or sections (e.g., the propulsion section 322, the payload section 324 and the POG section 326). In this embodiment, the outer surface 325 of the fuselage 320 includes faceted surface patterns, which are diamond and/or triangular shaped. As described for previous embodiments, the faceted geometry of the spline-shaped cylindrical fuselage 320 can provide a radar absorbing glazed finish and 3D printed embedded electrical circuitry. The fuselage 320 can have a length L1 measured from a first end to a second end of the fuselage 320 and a width W defined perpendicular to the length L1, and the rotorcraft 300, including the fuselage 320 and the legs (discussed below) when in a ready-to-use configuration can have a length L2, as shown in FIG. 9. As shown in FIG. 9, the length L1 is defined in a vertical direction and the width W is defined in a horizontal direction. As also shown in FIG. 9, the width W of the fuselage 320 can vary. In other embodiments, the width W may not vary. In some embodiments, the length L1 can be, for example, between about 15 inches and about 17 inches, and the length L2 can be, for example, between about 12 inches and about 15 inches. In some embodiments, the length L1 can be, for example, 1 foot, 3 3/16 inches, and the length L2 can be, for example, 1 foot, 53/64 inches.

The propulsion section 322, the payload section 324 and the POG section 326 can include the same or similar components as described above for rotorcrafts 100 and 200, and therefore, some details are not described with respect to FIGS. 9-13.

The propulsion section 322 of the rotorcraft 300 includes counter-rotating rotors (also referred to as “propellers”) 330 and 332 coupled to the fuselage 320 in close proximity to each other and at a top or forward end portion of the fuselage 320. The two rotors 330, 332 share a common and aligned rotational axis A-A (see FIG. 9), which is the longitudinal center axis of the fuselage 320. Each rotor 330, 332 includes or is coupled to a motor (not shown) disposed in a common aligned axis (e.g., axis A-A) within an interior region of the propulsion section 322. The rotors 330, 332 are coupled to the motors with a motor-shaft that enables concentric and balanced torque during operation. The motors are coupled to a bi-axial, servo controlled swash-plate assembly (not shown) also positioned within the fuselage 320. As described above for rotors 230, 232, the rotors 330, 332 can be foldable in the same manner as described above.

The payload section 324 serves as both a mechanical coupler of the POG and propulsion sections and can provide for interchangeability of a variety of different payloads, such as, but not limited to: an aerosol cartridge, micro-explosive ordnance, or small-parcel capsule as described above for rotorcrafts 100 and 200. The payload section 324 can include a payload (not shown) that can be removably interchangeable as described above

A computer control system (not shown) is also provided that can include, for example, a computer-based controller, at least one accelerometer, at least one gyroscope, a wireless interface, and a wireless transceiver. The control system can receive commands from a remote flight control platform through a wireless transceiver within the control system, and determine the rotor speed and swash-plate pitch angles necessary to achieve the flight commands received from a remote controller (not shown). Alternatively or in addition, some or all of the commands may be pre-programmed within a memory associated with the controller prior to operation of the rotorcraft 300.

The POG section 326 includes three flexible legs 328 positioned in 120 degree radial increments about the fuselage 320 and extending radially outward and downwardly from the fuselage 320. The legs 328 can be constructed and configured in the same or similar manner as described above for previous embodiments. For example, the legs can be retractable into the fuselage 320 through openings 327 defined in the fuselage 320. As described above, the legs 328 serve as the landing gear, and can also include other components such as, for example, integrated navigation lights, an antenna (e.g., a communications antenna), and provide an aerosol delivery catheter. Each of the legs 228 includes a landing shoe 329 located at the base of each leg 328 to serve as a surface foot. In some embodiments, the landing shoe 329 on at least one leg 328 can provide a light for illumination. The light can be connected to a control board (not shown) within the POG section 326, which can receive various commands from a wireless remote controller and transmit those commands to the various electronic components of the rotorcraft 300, including the led navigation light. The control board can provide for flight controls, GPS control, navigation and guidance of the rotorcraft 300, as described for previous embodiments.

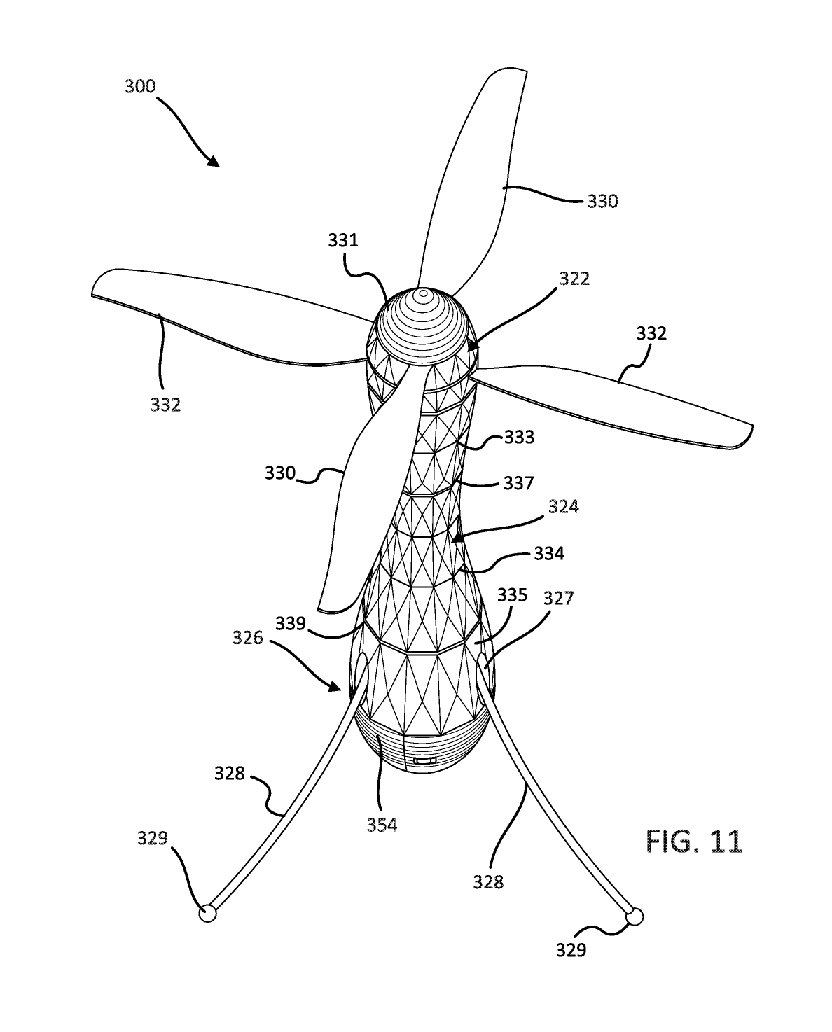

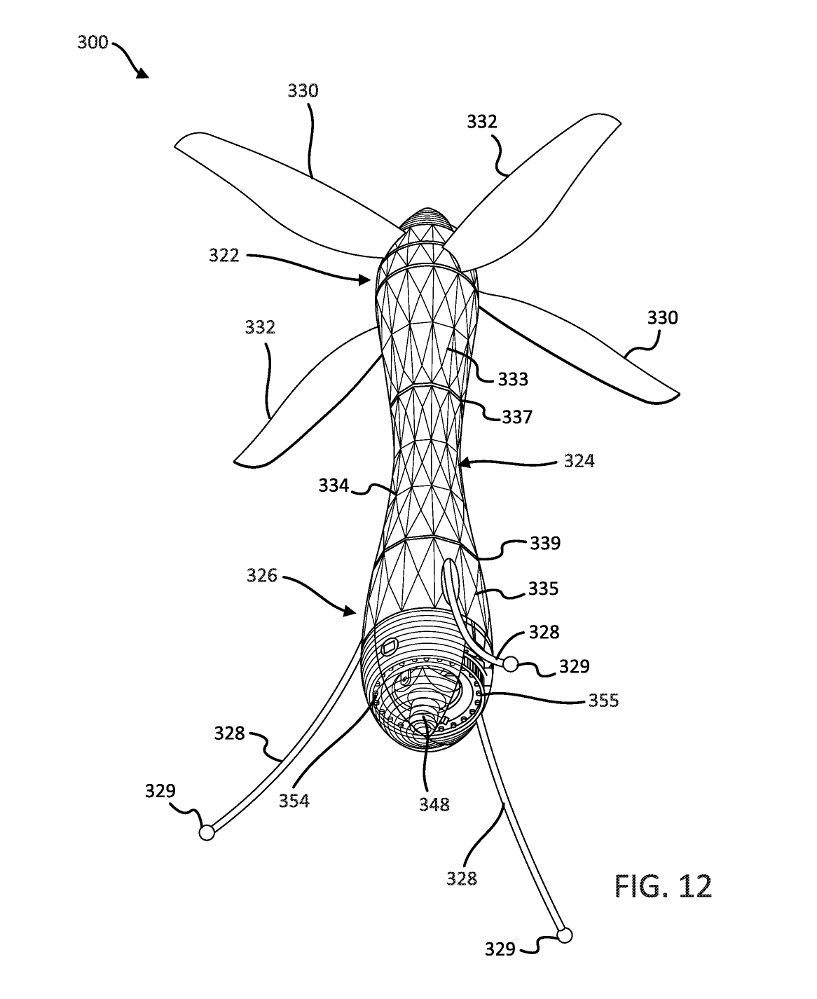

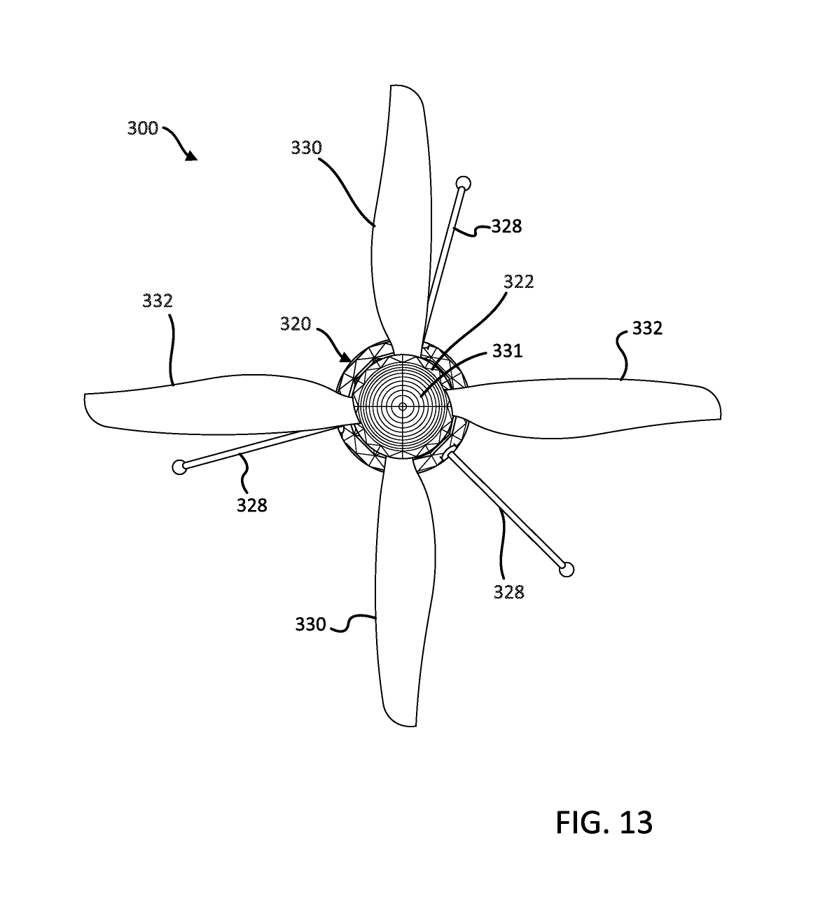

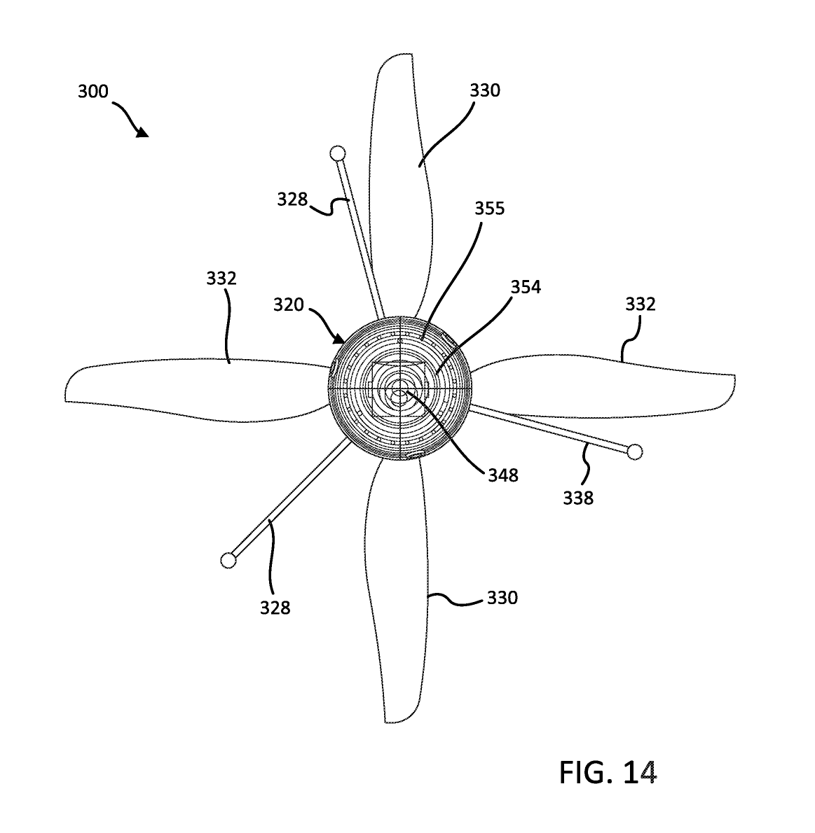

The POG section 326 can also include a power source (not shown), a camera 348, microphone(s), speakers, lights (e.g., LED ring 355 shown in, for example, FIGS. 11 and 13) and/or various sensors such as bio-aerosol detection and infra-red sensors (each not shown) as described for previous embodiments. A portion 354 of the fuselage 320 disposed at a bottom portion of the POG section 326 is formed with a clear polycarbonate lens to allow for images to be taken by the camera 348 through the fuselage 320.

As described above, the rotorcrafts (e.g., 100, 200, 300) described herein can be used for various purposes and provide various functions. For example, a rotorcraft can include various components such as sensors, lights, cameras, speakers, microphones, etc. The disclosed rotorcraft can be configured with various types of payloads. For example: an aerosol cartridge, explosives, micro-explosive ordinance, electronic communications hardware, chemical, bio-chemical detection sensors, pharmaceutical lancets or small-parcel capsule. A rotorcraft as described herein can be used for such tasks as surveillance and information collection (e.g., photographs, video, audio), audio functions such as audio emergency alarms or signaling, disruptive auditory engagement, disruptive aviary operations (crop protection and management), rescue operations (e.g., search capabilities), security (e.g., gas agent dispensing), law enforcement, fire-fighting management, pesticide delivery in micro-farming environments, offensive and defensive military operations, etc.

One example type of use of a rotorcraft (e.g., 100, 200, 300) described herein includes a law enforcement situational awareness application. In one such example application, a law enforcement officer working at night may come upon a vehicle pulled over to the side of the road where there may be little ambient light from which to view the occupants of the vehicle. In such a case, the officer can position his/her vehicle at a safe distance from the stopped vehicle, and deploy a rotorcraft as described herein. The officer can use an application provided on, for example, a phone, vehicle computer, tablet, etc. and bring up a 50 meter by 50 meter GPS map of the immediate area onscreen, while also sending the same information to dispatch. The officer draws a flight path with his or her finger on the tablet device, presses the launch button and the rotorcraft takes flight, in the direction of the vehicle. The rotorcraft can be piloted to circle the vehicle lighting up the area with integrated LED lights as described herein. The rotorcraft integrated speaker can be used to sound an alarm, waking a sleeping occupant. The information obtained by the rotorcraft can be sent from the rotorcraft and received back at the officer's tablet and dispatch, equipping the team with valuable situational data for tactical assessment, and response. Thus, the rotorcraft can be used to empower the officer with critical information, while lowering the event risk profile.

Another example law enforcement application includes a situation where law enforcement and protestors are at a face-off and the situation has escalated to where, for example, shields, batons, and make-shift weapons may be at issue. A typical crowd-control tactic is the use of incendiary type CS Tear Gas canisters launched or thrown indiscriminately into the crowd to disperse them. While effective, this tactic can increase the risk to all, raises liability, and further elevate situational aggression. In lieu of using such a tactic, a rotorcraft as described herein can be deployed with non-lethal auditory sirens to extend front-line force by the use of “disruptive auditory engagement” using high decibel speakers to irritate and disorient the individual or crowd for the purposes of disruption and disbanding of the crowd. Another example of crowd control by the rotorcraft is the disbursement of defensive non-lethal aerosol (CS tear-gas, pepper-spray and other chemical-control agents) through the pressurized aerosol delivery system. The rotorcraft can also record (e.g., photographs, video, audio recordings) the event for later evaluation by law-enforcement for possible post-event suspect apprehension.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated.

While various embodiments have been described above, it should be understood that they have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations. The embodiments described herein can include various combinations and/or sub-combinations of the functions, components, and/or features of the different embodiments described.

Where methods described above indicate certain events occurring in certain order, the ordering of certain events may be modified. Additionally, certain of the events may be performed concurrently in a parallel process when possible, as well as performed sequentially as described above.

What is claimed is:

1. An apparatus, comprising:
a fuselage of an unmanned aircraft including a first section, a second section and a third section, the first section being removably coupled to the second section, the second section being removably coupled to the third section such that the second section is disposed between the first section and the third section in a vertical direction,
the first section including a first rotor and a second rotor disposed at a non-zero spaced distance in the vertical direction from each other, the first rotor and the second rotor sharing a common and aligned rotational axis defined along a longitudinal centerline of the fuselage defined in the vertical direction,
the second section configured to contain a selected payload,
the third section including a control system; and
a plurality of legs coupled to the third section and configured to serve as landing gear for the unmanned aircraft.

2. The apparatus of claim 1, further comprising:
a motor disposed within the first section, the first rotor and the second rotor each operatively coupled to the motor.

3. The apparatus of claim 1, wherein the first section includes a first housing, the second section includes a second housing and the third section includes a third housing, the second housing removably coupled to the first housing and to the third housing such that the second housing is disposed between the first housing and the third housing in a vertical direction.

4. The apparatus of claim 3, wherein the first housing, the second housing and the third housing each include an exterior surface formed with radar absorbing material.

5. The apparatus of claim 3, wherein the first housing, the second housing and the third housing each include an exterior surface having a faceted geometry.

6. The apparatus of claim 1, wherein at least one leg from the plurality of legs defines a delivery lumen that extends through the leg and can be used to deliver a portion of a payload.

7. The apparatus of claim 1, further comprising:
a landing foot coupled to each leg from the plurality of legs, at least one landing foot including a light emitting device.

8. An apparatus, comprising:
a fuselage of an unmanned aircraft including a housing having a length and a width, the length defined in a vertical direction and the width defined substantially perpendicular to the length, the fuselage including a housing;
a first rotor coupled to the housing and a second rotor coupled to the housing and disposed at a non-zero spaced distance in the vertical direction from the first rotor,
the first rotor and the second rotor each configured to be moved between a first configuration in which the first rotor and the second rotor are disposed at substantially ninety degrees relative to an outer surface of the housing of the fuselage for use of the unmanned vehicle, and a second configuration in which the first rotor and the second rotor are disposed substantially parallel to a longitudinal centerline of the fuselage defined along the length of the fuselage for storage and transport of the unmanned vehicle; and
a plurality of legs coupled to the fuselage and configured to serve as landing gear for the unmanned aircraft, the plurality of legs each configured to be moved between a first configuration in which the legs are extended for use as landing gear for the unmanned vehicle and a second configuration in which the plurality of legs are disposed at least partially within a portion of the housing for storage and transport of the unmanned vehicle.

9. The apparatus of claim 8, wherein the first rotor and the second rotor share a common and aligned rotational axis defined along a longitudinal centerline of the fuselage defined in the vertical direction.

10. The apparatus of claim 9, further comprising:
a first motor disposed within the housing and operatively coupled to the first rotor and a second motor disposed within the housing and operatively coupled to the second rotor.

11. The apparatus of claim 8, wherein at least one leg from the plurality of legs defines a delivery lumen that extends through the leg and can be used to deliver a payload.

12. The apparatus of claim 8, further comprising:
a landing foot coupled to each leg from the plurality of legs, at least one landing foot including a light emitting device.

13. The apparatus of claim 8, wherein the fuselage includes a first section, a second section and a third section, the first section being removably coupled to the second section, the second section being removably coupled to the third section such that the second section is disposed between the first section and the third section in a vertical direction.

14. The apparatus of claim 13, wherein the first rotor and the second rotor are disposed on the first section and share a common and aligned rotational axis defined along the longitudinal center of the fuselage defined in the vertical direction,
the second section configured to contain a selected payload, and
the third section including a control system.

15. An apparatus, comprising:
a fuselage of an unmanned aircraft including a housing having a length and a width, the length defined in a vertical direction and the width defined substantially perpendicular to the length;
a first rotor and a second rotor each coupled to the housing and disposed at a non-zero spaced distance in the vertical direction from each other, the first rotor and the second rotor sharing a common and aligned rotational axis defined along a longitudinal centerline of the fuselage;
a first motor included within the housing and operatively coupled to the first rotor;
a second motor included within the housing and operatively coupled to the second rotor, the first motor and the second motor each aligned with the first rotor and the second rotor along the longitudinal centerline of the fuselage; and
a power source disposed within the housing and operatively coupled to the first motor and to the second motor.

16. The apparatus of claim 15,wherein the fuselage includes a first section, a second section and a third section, the first section being removably coupled to the second section, the second section being removably coupled to the third section such that the second section is disposed between the first section and the third section in a vertical direction.

17. The apparatus of claim 16, wherein the first section is disposed at a top end of the fuselage and the third section is disposed at a bottom end of the fuselage, the first rotor, the second rotor, the first motor and the second motor are each included on the first section, the power source is included on the third section.

18. The apparatus of claim 16, wherein the second section is configured to contain a payload.

19. The apparatus of claim 15,further comprising:
a plurality of legs coupled to the fuselage and configured to serve as landing gear for the unmanned aircraft.

20. The apparatus of claim 19, wherein at least one leg from the plurality of legs defines a delivery lumen that extends through the leg and can be used to deliver a payload.

21. The apparatus of claim 19, further comprising:
a landing foot coupled to each leg from the plurality of legs, at least one landing foot including a light emitting device.
